(19) United States
(12) Patent Application Publication
(10) Pub. No.: US 2023/0318070 A1
(43) Pub. Date: Oct. 5, 2023

(54) TEMPERATURE ADJUSTING DEVICE AND VEHICLE

(71) Applicant: HONDA MOTOR CO., LTD., Tokyo (JP)

(72) Inventor: Yasushi Ogihara, Wako-shi (JP)

(21) Appl. No.: 18/125,151

(22) Filed: Mar. 23, 2023

(30) Foreign Application Priority Data
Mar. 31, 2022 (JP) 2022-059643

(51) Int. Cl. H01M 10/63; H01M 10/615; H01M 10/613; H01M 10/6568; H01M 10/48; H01M 10/66; H01M 10/44; H01M 10/625; B60L 58/26; B60L 58/27

(52) U.S. Cl. CPC H01M 10/63; H01M 10/615; H01M 10/613; H01M 10/6568; H01M 10/486; H01M 10/66; H01M 10/44; H01M 10/625; B60L 58/26; B60L 58/27; H01M 2220/20

(57) ABSTRACT

A temperature adjusting device includes temperature adjusting circuit that circulates thermal medium, first temperature sensor that measures temperature of thermal medium, battery thermally connected to the temperature adjusting circuit, second temperature sensor that measures temperature of the battery, heat generating instrument thermally connected to the temperature adjusting circuit, flow channel switching device that switches flow channel of the temperature adjusting circuit to form first temperature adjusting circuit which connects downstream of the battery and upstream of the heat generating instrument and second temperature adjusting circuit which connects downstream side of the battery and downstream side of the heat generating instrument, and control device that controls the flow channel switching device and that has intermittent operating mode of intermittently switching the temperature adjusting circuit to the first temperature adjusting circuit or the second temperature adjusting circuit based on the measurement results of the first temperature sensor and the second temperature sensor.

### CROSS-REFERENCE TO RELATED APPLICATION

Priority is claimed on Japanese Patent Application No. 2022-059643, filed Mar. 31, 2022, the content of which is incorporated herein by reference.

### BACKGROUND OF THE INVENTION

### Field of the Invention

The present invention relates to a temperature adjusting device and a vehicle.

### Description of Related Art

In recent years, in order to ensure access to affordable, reliable, sustainable and advanced energy for more people, research and development have been carried out on secondary batteries that contribute to energy efficiency.

Japanese Unexamined Patent Application, First Publication No. 2019-23059 discloses a cooling water flow channel that includes a first cooling water flow channel which cools a battery and a second cooling water flow channel which cools a motor generator and an inverter, and that is configured to connect and separate the first cooling water flow channel and the second cooling water flow channel according to an ambient temperature or a battery water temperature.

### SUMMARY OF THE INVENTION

Incidentally, in a technology related to a secondary battery, the weight and costs of temperature adjusting devices become an issue. For example, the battery and the heat generating instrument (the motor generator, the inverter, and the like) have the two cooling water flow channels as described above because the management temperatures are different. When temperatures of two such cooling water circuits are managed independently or connected to each other, flow channel parts such as a flow channel switching valve, a flow channel pipeline, or the like increase.

An aspect of the present application is directed to accomplishing a reduction in size and a reduction in weight of a temperature adjusting device of a battery and a heat generating instrument. Further, an aspect of the present application is to contribute to energy efficiency.

A temperature adjusting device and a vehicle according to the present invention employ the following configurations.

(1) A temperature adjusting device according to an aspect of the present invention includes a temperature adjusting circuit configured to circulate a thermal medium; a first temperature sensor configured to measure a temperature of the thermal medium; a battery thermally connected to the temperature adjusting circuit; a second temperature sensor configured to measure a temperature of the battery; a heat generating instrument thermally connected to the temperature adjusting circuit; a flow channel switching device that is configured to switch a flow channel of the temperature adjusting circuit so as to form a first temperature adjusting circuit which connects a downstream side of the battery and an upstream side of the heat generating instrument and a second temperature adjusting circuit which connects a downstream side of the battery and a downstream side of the heat generating instrument; and a control device that is configured to control the flow channel switching device and that has an intermittent operating mode of intermittently switching the temperature adjusting circuit to the first temperature adjusting circuit or the second temperature adjusting circuit on the basis of the measurement results of the first temperature sensor and the second temperature sensor.

(2) In the aspect of the above-mentioned (1), the control device may shorten time for intermittently switching between the first temperature adjusting circuit and the second temperature adjusting circuit as the measurement result of the first temperature sensor becomes higher.

(3) In the aspect of the above-mentioned (1) or (2), the heat generating instrument may have a thermal capacity smaller than that of the battery.

(4) In the aspect of the above-mentioned (3), the control device may have a normal operating mode of controlling the flow channel switching device and setting the temperature adjusting circuit to the second temperature adjusting circuit in a case the measurement results of the first temperature sensor and the second temperature sensor are less than a predetermined threshold and the measurement result of the first temperature sensor is equal to or greater than the measurement result of the second temperature sensor, and the control device switches from the normal operating mode to the intermittent operating mode in a case the measurement results of the first temperature sensor and the second temperature sensor are less than the threshold and the measurement result of the first temperature sensor is less than the measurement result of the second temperature sensor.

(5) In the aspect of the above-mentioned (4), a radiator thermally that is connected to the temperature adjusting circuit and that is configured to cool the thermal medium may be provided, and the control device may have a cooling operating mode of cooling the thermal medium using the radiator in a case the measurement results of the first temperature sensor and the second temperature sensor are equal to or greater than the threshold.

(6) In the aspects of the above-mentioned (1) to (5), the heat generating instrument may include a driving device configured to drive a motor.

(7) In the aspects of the above-mentioned (1) to (6), the heat generating instrument may include a charging device that is electrically connected to an external power supply and that is configured to charge the battery.

(8) A vehicle according to an aspect of the present invention includes the temperature adjusting device of the aspects of the above-mentioned (1) to (7).

According to the aspects of the above-mentioned (1) to (8), since the flow channel of the temperature adjusting circuit can be intermittently switched to manage the temperatures of the battery and the heat generating instrument, the flow channel parts of the temperature adjusting device can be reduced rather than making the temperature adjusting circuit of the battery and the heat generating instrument independent. Accordingly, it is possible to accomplish a reduction in size and weight of the temperature adjusting device of the battery and the heat generating instrument.

### BRIEF DESCRIPTION OF THE DRAWINGS

FIG. 1 is a circuit diagram showing a configuration of a temperature adjusting device according to an embodiment.

FIG. 2 is a block diagram showing a control system of the temperature adjusting device according to the embodiment.

FIG. 3 is a view for describing an intermittent operating mode according to the embodiment.

FIG. 4 is a view for describing a normal operating mode according to the embodiment.

FIG. 5 is a view for describing a cooling operating mode according to the embodiment.

FIG. 6 is a view showing a control map of a control device according to the embodiment.

FIG. 7 is a perspective view showing a schematic configuration of a vehicle according to the embodiment.

### DETAILED DESCRIPTION OF THE INVENTION

Hereinafter, an embodiment of the present invention will be described with reference to the accompanying drawings.

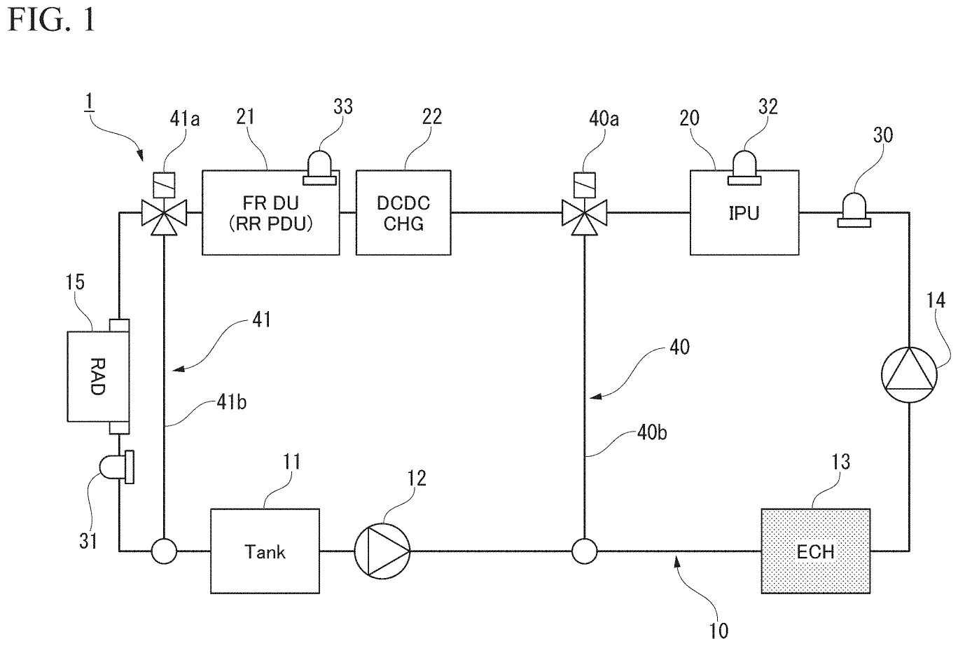

FIG. 1 is a circuit diagram showing a configuration of a temperature adjusting device 1 according to an embodiment.

The temperature adjusting device 1 is mounted in a vehicle (not shown). The vehicle may be an electric vehicle having only a motor serving as a driving source, or may be a hybrid vehicle having a motor and an internal combustion engine.

As shown in FIG. 1, the temperature adjusting device 1 includes a temperature adjusting circuit 10 configured to circulate a thermal medium.

A battery (IPU) 20 is thermally connected to the temperature adjusting circuit 10. In addition, a driving device (FR DU, RR PDU) 21 or a charging device (DCDC CHG) 22 is thermally connected to the temperature adjusting circuit 10 as a heat generating instrument. The heat generating instrument (the driving device 21, the charging device 22) is disposed downstream from the battery 20 in the temperature adjusting circuit 10.

The battery 20 supplies electric power to at least one of an electronic system, an air-conditioning system, and a driving system of the vehicle. The battery 20 is a secondary battery that is chargeable and dischargeable. As the secondary battery, a solid-state battery having a wide management temperature range in charging and discharging is preferable. The solid-state battery is a battery filled with a solid electrolyte between a positive electrode and a negative electrode with no electrolytic liquid. Further, the secondary battery may be a known lithium ion battery or the like having an electrolytic liquid.

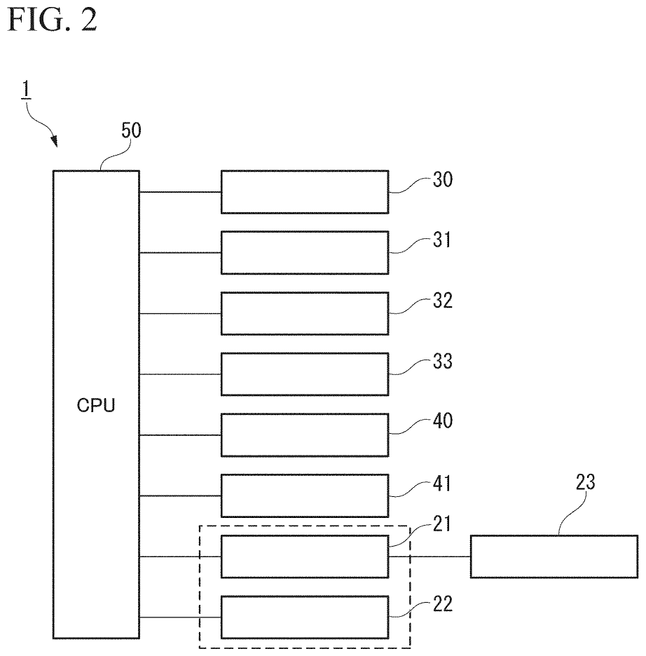

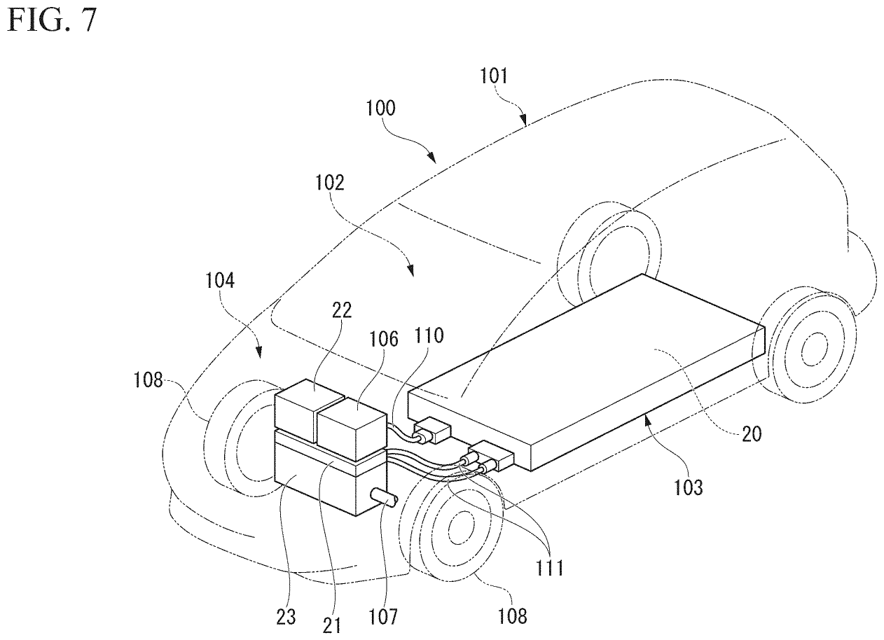

The driving device 21 is electrically connected to the battery 20, and drives a motor 23 (see FIG. 2 and FIG. 7) of the vehicle. The driving device 21 includes an inverter (electric power conversion device) configured to convert direct current electric power into alternating current electric power and convert alternating current electric power into direct current electric power. The charging device 22 is electrically connected to the battery 20, and charges the battery 20 when electrically connected to an external power supply (not shown). The charging device 22 includes a DC/DC converter configured to boost or drop a direct current voltage.

These heat generating instruments (the driving device 21, the charging device 22) have a thermal capacity smaller than that of the battery 20. In the embodiment, each of the driving device 21 and the charging device 22 has a thermal capacity smaller than that of the battery 20. In addition, even when the thermal capacities of the driving device 21 and the charging device 22 are added, the sum is smaller than the thermal capacity of the battery 20.

The temperature adjusting circuit 10 includes a reservoir tank 11, a first pump 12, a water heating electric heater (ECH) 13, a second pump 14, a radiator (RAD) 15, a first flow channel switching device 40, and a second flow channel switching device 41. The reservoir tank 11 stores a thermal medium and injects the thermal medium into the temperature adjusting circuit 10. For example, the thermal medium is water, radiator liquid, coolant liquid, or the like. The first pump 12 is disposed downstream from the reservoir tank 11 in the temperature adjusting circuit 10. The first pump 12 supplies the thermal medium injected from the reservoir tank 11 into the water heating electric heater 13.

The water heating electric heater 13 is disposed downstream from the first pump 12 in the temperature adjusting circuit 10. The water heating electric heater 13 heats the thermal medium. The second pump 14 is disposed downstream from the water heating electric heater 13 in the temperature adjusting circuit 10. The second pump 14 supplies the thermal medium flowing through the water heating electric heater 13 into the battery 20. The radiator 15 is disposed downstream from the driving device 21 in the temperature adjusting circuit 10. The radiator 15 exchanges heat between the thermal medium and the outdoor air.

The first flow channel switching device 40 includes a first flow channel switching valve 40a and a first bias flow channel 40b. The first flow channel switching valve 40a is an electrically driven multi-way valve (in the embodiment, a three-way valve) disposed downstream from the battery 20. The first flow channel switching valve 40a guides the thermal medium flowing through the battery 20 toward an upstream side of the charging device 22, or toward an upstream side of the water heating electric heater 13 via the first bias flow channel 40b.

The second flow channel switching device 41 includes a second flow channel switching valve 41a and a second bias flow channel 41b. The second flow channel switching valve 41a is an electrically driven multi-way valve (in the embodiment, a three-way valve) disposed downstream from the driving device 21. The second flow channel switching valve 41a guides the thermal medium flowing through the driving device 21 toward an upstream side of the radiator 15 or toward an upstream side of the reservoir tank 11 via the second bias flow channel 41b. Further, when an opening/closing device (for example, an active grill shutter) configured to open and close a ventilating hole through which the radiator 15 takes in an outdoor air, the second flow channel switching device 41 is optional.

The temperature adjusting device 1 of the above-mentioned configuration includes a plurality of temperature sensors 30, 31, 32 and 33. The temperature sensor 30 is installed at an inlet of the battery 20 in the temperature adjusting circuit 10 and measures a temperature of the thermal medium. In addition, the temperature sensor 31 is installed at an outlet of the radiator 15 in the temperature adjusting circuit 10 and measures a temperature of the thermal medium. In addition, the temperature sensor 32 is installed in the battery 20 and measures a temperature of the battery 20. In addition, the temperature sensor 33 is installed in the driving device 21 and measures a temperature of the driving device 21.

Next, a control system of the temperature adjusting device 1 of the above-mentioned configuration will be described.

FIG. 2 is a block diagram showing the control system of the temperature adjusting device 1 according to the embodiment.

As shown in FIG. 2, the temperature adjusting device 1 includes a control device 50 that is electrically connected to the plurality of temperature sensors 30, 31, 32 and 33, the first flow channel switching device 40, and the second flow channel switching device 41, and that is electrically connected to the battery 20 and the heat generating instruments (the driving device 21, the charging device 22). The control device 50 includes a plurality of operating modes of managing temperatures of the battery 20 and the heat generating instruments.

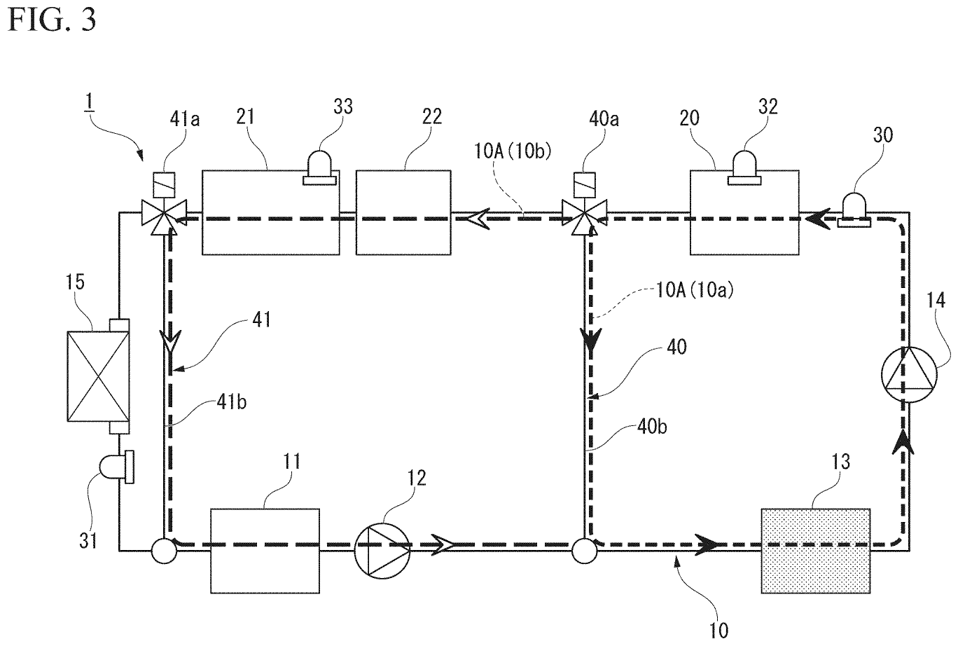

FIG. 3 is a view for describing an intermittent operating mode 10A according to the embodiment.

As shown in FIG. 3, the control device 50 has the intermittent operating mode 10A of controlling the first flow channel switching device 40 and intermittently switching the temperature adjusting circuit 10 to a first temperature adjusting circuit 10a or a second temperature adjusting circuit 10b. The intermittent operating mode 10A is an operating mode of heating mainly the battery 20 with a large thermal capacity.

Further, during the intermittent operating mode 10A, the water heating electric heater 13 heats the thermal medium (a water heating electric heater ON). In addition, during the intermittent operating mode 10A, the second flow channel switching device 41 connects a downstream side of the driving device 21 and an upstream side of the reservoir tank 11 (a radiator OFF).

In the first temperature adjusting circuit 10a, the first flow channel switching device 40 connects a downstream side of the battery 20 and an upstream side of the water heating electric heater 13. The first temperature adjusting circuit 10a is a small circulation circuit in which the thermal medium heated by the water heating electric heater 13 and sent from the second pump 14 returns to the water heating electric heater 13 through the battery 20, the first flow channel switching valve 40a, and the first bias flow channel 40b. Further, when switched to the first temperature adjusting circuit 10a, the first pump 12 is stopped.

Meanwhile, in the second temperature adjusting circuit 10b, the first flow channel switching device 40 connects a downstream side of the battery 20 and an upstream side of the charging device 22. The second temperature adjusting circuit 10b is a large circulation circuit in which the thermal medium sent from the first pump 12 returns to the reservoir tank 11 through the water heating electric heater 13, the second pump 14, the battery 20, the first flow channel switching valve 40a, the charging device 22, the driving device 21, the second flow channel switching valve 41a, and the second bias flow channel 41b.

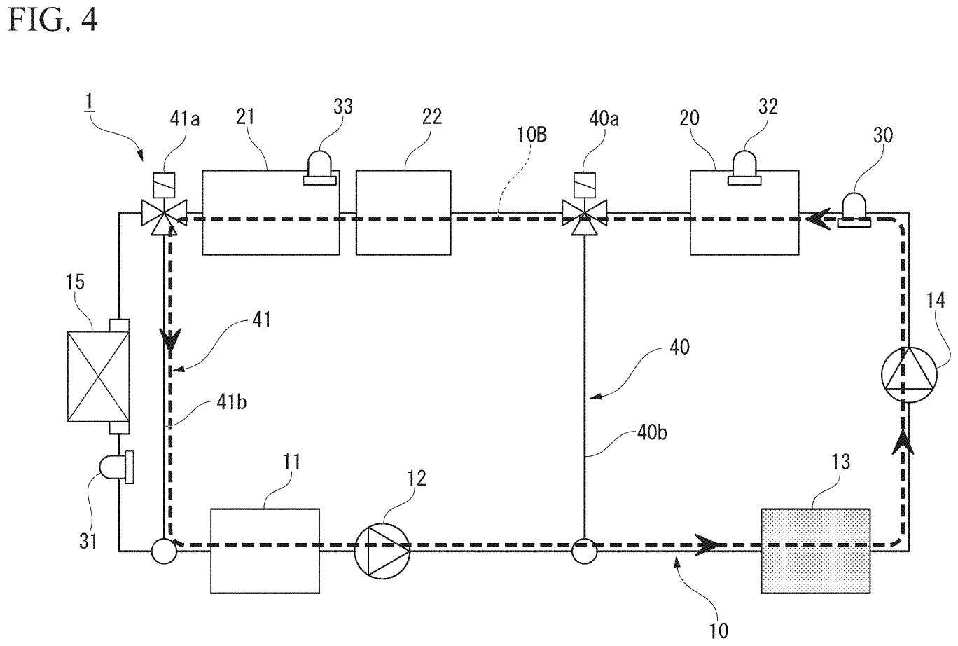

FIG. 4 is a view for describing a normal operating mode 10B according to the embodiment.

As shown in FIG. 4, the control device 50 has the normal operating mode 10B of controlling the first flow channel switching device 40 and setting the temperature adjusting circuit 10 to the second temperature adjusting circuit 10b. The normal operating mode 10B is an operating mode of heating the battery 20 and the heat generating instruments, which are at a low temperature.

Further, during the normal operating mode 10B, the water heating electric heater 13 heats the thermal medium (the water heating electric heater ON). In addition, during the normal operating mode 10B, the second flow channel switching device 41 connects a downstream side of the driving device 21 and an upstream side of the reservoir tank 11 (the radiator OFF).

In the normal operating mode 10B, the thermal medium sent from the first pump 12 returns to the reservoir tank 11 through the water heating electric heater 13, the second pump 14, the battery 20, the first flow channel switching valve 40a, the charging device 22, the driving device 21, the second flow channel switching valve 41a, and the second bias flow channel 41b.

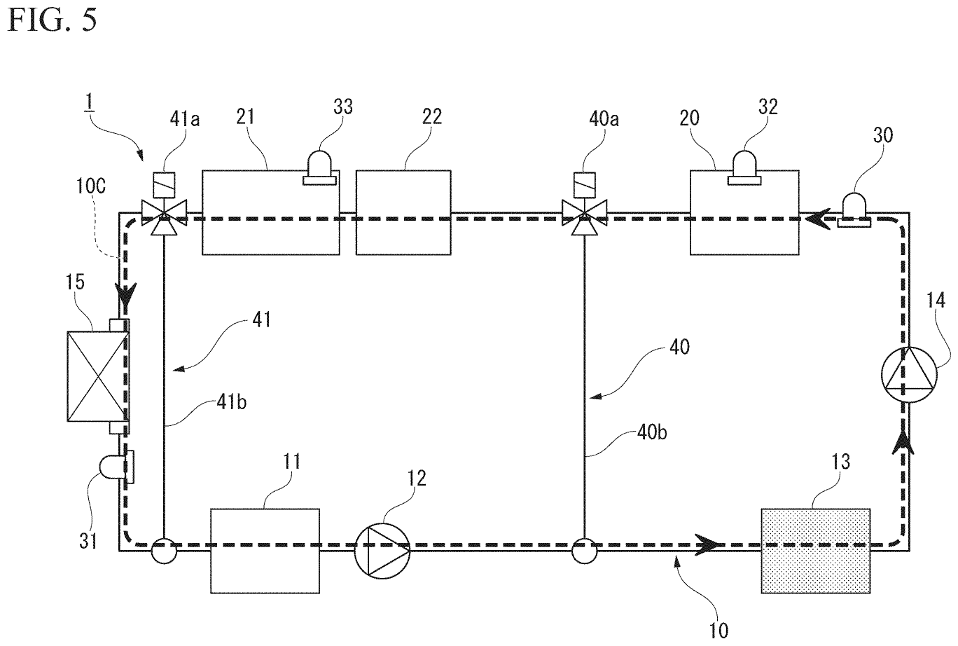

FIG. 5 is a view for describing a cooling operating mode 10C according to the embodiment.

As shown in FIG. 5, the control device 50 has the cooling operating mode 10C of controlling the second flow channel switching device 41 and cooling the thermal medium using the radiator 15. The cooling operating mode 10C is an operating mode of cooling the battery 20 and the heat generating instruments, which are at a high temperature.

Further, during the cooling operating mode 10C, the water heating electric heater 13 does not heat the thermal medium (the water heating electric heater OFF). In addition, during the cooling operating mode 10C, the second flow channel switching device 41 connects a downstream side of the driving device 21 and an upstream side of the radiator 15 (the radiator ON).

In the cooling operating mode 10C, the thermal medium sent from the first pump 12 returns to the reservoir tank 11 through the water heating electric heater 13, the second pump 14, the battery 20, the first flow channel switching valve 40a, the charging device 22, the driving device 21, the second flow channel switching valve 41a, and the radiator 15.

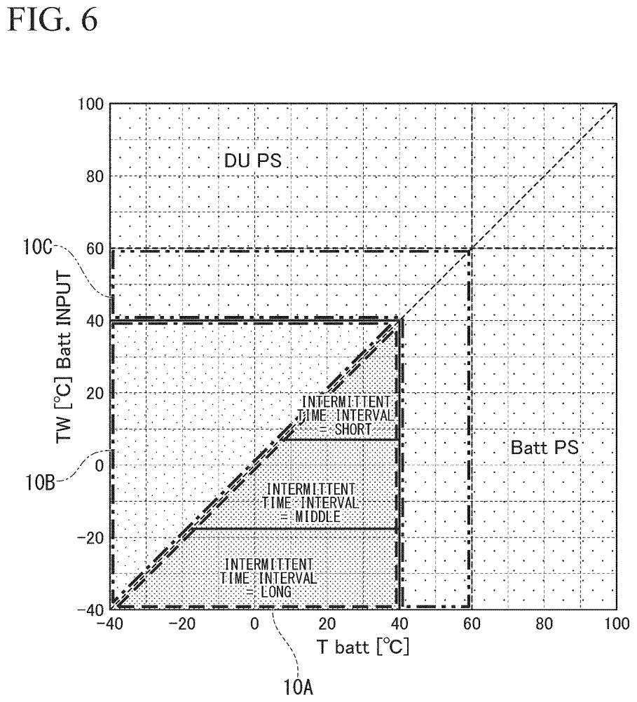

FIG. 6 is a view showing a control map of the control device 50 according to the embodiment.

As shown in FIG. 6, the control device 50 switches an operating mode to the intermittent operating mode 10A, the normal operating mode 10B or the cooling operating mode 10C on the basis of a measurement result (TW) of the temperature sensor 30 (a temperature of a thermal medium in the inlet of the battery 20) and a measurement result (Tbatt) of the temperature sensor 31 (a temperature of the battery 20 itself).

Specifically, the control device 50 heats the battery 20 and the heat generating instruments in the normal operating mode 10B when the measurement results of the temperature sensor 30 and the temperature sensor 32 are less than 40° C. (a predetermined threshold) and a measurement result (TW) of the temperature sensor 30 is equal or greater than a measurement result (Tbatt) of the temperature sensor 32.

During the normal operating mode 10B, as shown in FIG. 4, the thermal medium heated by the water heating electric heater 13 is supplied into the battery 20 and the heat generating instruments (the driving device 21, the charging device 22). Accordingly, the battery 20 and the heat generating instruments can be heated similarly. Further, since the thermal capacity of the heat generating instruments is smaller than the thermal capacity of the battery 20, in the normal operating mode 10B, the heat generating instruments are easily heated before the battery 20.

In a case the measurement results of the temperature sensor 30 and the temperature sensor 32 are less than 40° C. (the predetermined threshold), and the measurement result (TW) of the temperature sensor 30 is less than the measurement result (Tbatt) of the temperature sensor 32, the control device 50 switches the operating mode from the normal operating mode 10B to the intermittent operating mode 10A and heats the battery 20 and the heat generating instruments.

In the intermittent operating mode 10A, as shown in FIG. 3, the temperature adjusting circuit 10 is intermittently switched to the first temperature adjusting circuit 10a or the second temperature adjusting circuit 10b. The battery 20 is heated by the thermal medium heated by the water heating electric heater 13 when switched to the first temperature adjusting circuit 10a. Here, while the side of the heat generating instrument where the thermal medium does not flow is not heated, the thermal medium is heated by the driving heat of the heat generating instrument.

Then, when switched to the second temperature adjusting circuit 10b, the battery 20 is heated by the thermal medium heated by the water heating electric heater 13 and is heated by the thermal medium hated by the driving heat of the heat generating instrument while it has been switched to the first temperature adjusting circuit 10a. In this way, the battery 20 can be preferentially heated by the heat generating instrument by switching to the intermittent operating mode 10A.

As shown in FIG. 6, the control device 50 shortens the time for intermittently switching between the first temperature adjusting circuit 10a and the second temperature adjusting circuit 10b as the measurement result (TW) of the temperature sensor 30 becomes higher. The control device 50 of the embodiment shortens the time interval for intermittently switching between the first temperature adjusting circuit 10a and the second temperature adjusting circuit 10b step by step (in the embodiment, long (for example, 5 minutes), middle (for example, 3 minutes) and short (for example, 1 minute)) within a range of 0° C. to 40° C. of the measurement result (TW) of the temperature sensor 30. Accordingly, it is possible to avoid overheating of the battery 20 in the intermittent operating mode 10A.

Accordingly, the battery 20 can be heated from a low temperature output drop state to a normal output state (for example, 40° C. to 60° C.) that can output the required output.

In addition, the control device 50 cools the battery 20 and the heat generating instruments in the cooling operating mode 10C when the measurement results of the temperature sensor 30 and the temperature sensor 32 are equal to or greater than 40° C. (Predetermined threshold).

During the cooling operating mode 10C, the water heating electric heater 13 is turned OFF and the radiator 15 is turned ON, and as shown in FIG. 5, the thermal medium cooled by the radiator 15 is supplied to the battery 20 and the heat generating instruments. Accordingly, the battery 20 and the heat generating instruments can be cooled to prevent the battery 20 and the heat generating instruments from becoming a high temperature (for example, 60° C. or more) and from being controlled under power save (PS) operation.

According to the temperature adjusting device 1 of the above-mentioned configuration, since the temperature of the battery 20 can be managed pseudo-independently from the heat generating instrument by intermittently switching the flow channel of the temperature adjusting circuit 10, the flow channel parts (for example, the same flow channel parts or the like installed parallel to the first flow channel switching device 40) of the temperature adjusting device 1 can be reduced rather than independently installing the temperature adjusting circuit 10 of the battery 20 and the heat generating instruments. Accordingly, it is possible to accomplish reduction in size and weight of the temperature adjusting device 1 of the battery 20 and the heat generating instruments.

In this way, the temperature adjusting device 1 according to the above-mentioned embodiment includes the temperature adjusting circuit 10 configured to circulate the thermal medium, the temperature sensor 30 (a first temperature sensor) configured to measure a temperature of the thermal medium, the battery 20 thermally connected to the temperature adjusting circuit 10, the temperature sensor 32 (a second temperature sensor) configured to measure a temperature of the battery 20, the heat generating instruments (the driving device 21, the charging device 22) thermally connected to the temperature adjusting circuit 10, the first flow channel switching device 40 (a flow channel switching device) that is configured to switch the flow channel of the temperature adjusting circuit 10 so as to form the first temperature adjusting circuit 10a which connects a downstream side of the battery 20 and an upstream side of the heat generating instrument and the second temperature adjusting circuit 10b which connects a downstream side of the battery 20 and a downstream side of the heat generating instrument, and the control device 50 that is configured to control the first flow channel switching device 40 and that has the intermittent operating mode 10A of intermittently switching the temperature adjusting circuit 10 to the first temperature adjusting circuit 10a or the second temperature adjusting circuit 10b on the basis of the measurement results of the temperature sensor 30 and the temperature sensor 32. According to the configuration, it is possible to accomplish reduction in size and weight of the temperature adjusting device 1 of the battery 20 and the heat generating instruments.

In addition, in the embodiment, the control device 50 shortens the time for intermittently switching between the first temperature adjusting circuit 10a and the second temperature adjusting circuit 10b as the measurement result of the temperature sensor 32 becomes higher. According to the configuration, it is possible to avoid overheating of the battery 20 in the intermittent operating mode 10A.

In addition, in the embodiment, the heat generating instrument has a thermal capacity smaller than that of the battery 20. According to the configuration, since the temperature of the thermal medium and the temperature of the heat generating instrument are responsive, it is possible to manage a heat generating state of the heat generating instrument on the basis of a change in temperature of the thermal medium (the measurement result of the temperature sensor 30).

In addition, in the embodiment, the control device 50 has the normal operating mode 10B of controlling the first flow channel switching device 40 and setting the temperature adjusting circuit 10 to the second temperature adjusting circuit 10b in a case the measurement results of the temperature sensor 30 and the temperature sensor 32 are less than 40° C. (predetermined threshold) and the measurement result of the temperature sensor 30 is equal to or greater than the measurement result of the temperature sensor 32, and the control device switches from the normal operating mode 10B to the intermittent operating mode 10A in a case the measurement results of the temperature sensor 30 and the temperature sensor 32 are less than 40° C. and the measurement result of the temperature sensor 30 is less than the measurement result of the temperature sensor 32. According to the configuration, when the heat generating instrument having the thermal capacity smaller than that of the battery 20 heats up first while heating the battery 20 and the heat generating instruments in the same way in the normal operating mode 10B, it is possible to switch to the intermittent operating mode 10A to give priority to heating the battery 20.

In addition, in the embodiment, further including the radiator 15 thermally that is connected to the temperature adjusting circuit 10 and that is configured to cool the thermal medium, the control device 50 has the cooling operating mode 10C configured to cool the thermal medium using the radiator 15 in a case the measurement results of the temperature sensor 30 and the temperature sensor 32 are equal to or greater than 40° C. According to the configuration, the battery 20 and the heat generating instruments can be cooled to prevent the battery 20 and the heat generating instruments from becoming a high temperature (for example, 60° C. or more) and from being controlled under power save (PS) operation.

In addition, in the embodiment, the heat generating instrument includes the driving device 21 configured to drive the motor 23. According to the configuration, the battery 20 can be heated through the thermal medium heated by the heat generated by the driving device 21.

In addition, in the embodiment, the heat generating instrument includes the charging device 22 that is electrically connected to an external power supply and that is configured to charge the battery 20. According to the configuration, the battery 20 can be heated through the thermal medium heated by the heat generated by the charging device 22.

FIG. 7 is a perspective view showing a schematic configuration of a vehicle 100 according to the embodiment.

A vehicle body 101 of the vehicle 100 is provided with a battery case 103 configured to accommodate the battery 20 in an underfloor portion of a passenger compartment 102. A motor room 104 is provided in a front section of the vehicle 100. A motor 23, a driving device 21, a branch unit 106, a charging device 22, and the like, are provided in the motor room 104.

A rotary driving force of the motor 23 is transmitted to a shaft 107. A front wheel 108 of the vehicle 100 is connected to both end portions of the shaft 107. The driving device 21 is disposed above the motor 23 and directly fastened and fixed to a case of the motor 23. The driving device 21 is electrically connected to a connector of the battery case 103 by a power supply cable 111. In addition, the driving device 21 is electrically connected to the motor 23 by, for example, a three-phase pass bar. The driving device 21 controls driving of the motor 23 using electric power supplied from the battery 20.

The branch unit 106 and the charging device 22 are disposed laterally in parallel. The branch unit 106 and the charging device 22 are disposed above the driving device 21. The branch unit 106 and the charging device 22 are disposed while being separated from the driving device 21. The branch unit 106 and the battery case 103 are electrically connected by a cable 110 having connectors on both ends.

The branch unit 106 is electrically connected to the charging device 22. The charging device 22 is connected to a general external power supply such as a domestic power source or the like and performs charging to the battery 20. The charging device 22 and the branch unit 106 are electrically connected by a cable (not shown) having connectors on both ends.

Since the above-mentioned vehicle 100 includes the above-mentioned temperature adjusting device 1, it is possible to accomplish reduction in size and weight of the temperature adjusting device 1 of the battery 20. In this way, it is possible to increase an electric mileage and improve vehicle efficiency as the temperature adjusting device 1 is reduced in size and weight.

Hereinabove, while the preferred embodiments of the present invention have been disclosed and described, it is to be understood that they are exemplary of the present invention and should not be considered limiting. Additions, omissions, substitutions, and other modifications can be made without departing from the scope of the present invention. Accordingly, the invention is not to be considered as being limited by the foregoing description, and is only limited by the scope of the appended claims.

For example, in the embodiment, while the threshold for switching from the intermittent operating mode 10A or the normal operating mode 10B to the cooling operating mode 10C is set to 40° C., the threshold is an example and can be changed as appropriate depending on specifications of the battery 20 or the heat generating instrument.

What is claimed is:

1. A temperature adjusting device comprising:
a temperature adjusting circuit configured to circulate a thermal medium;
a first temperature sensor configured to measure a temperature of the thermal medium;
a battery thermally connected to the temperature adjusting circuit;
a second temperature sensor configured to measure a temperature of the battery;
a heat generating instrument thermally connected to the temperature adjusting circuit;
a flow channel switching device that is configured to switch a flow channel of the temperature adjusting circuit so as to form a first temperature adjusting circuit which connects a downstream side of the battery and an upstream side of the heat generating instrument and a second temperature adjusting circuit which connects a downstream side of the battery and a downstream side of the heat generating instrument; and
a control device that is configured to control the flow channel switching device and that has an intermittent operating mode of intermittently switching the temperature adjusting circuit to the first temperature adjusting circuit or the second temperature adjusting circuit on the basis of the measurement results of the first temperature sensor and the second temperature sensor.

2. The temperature adjusting device according to claim 1, wherein the control device shortens time for intermittently switching between the first temperature adjusting circuit and the second temperature adjusting circuit as the measurement result of the first temperature sensor becomes higher.

3. The temperature adjusting device according to claim 1, wherein the heat generating instrument has a thermal capacity smaller than that of the battery.

4. The temperature adjusting device according to claim 3, wherein the control device has a normal operating mode of controlling the flow channel switching device and setting the temperature adjusting circuit to the second temperature adjusting circuit in a case the measurement results of the first temperature sensor and the second temperature sensor are less than a predetermined threshold and the measurement result of the first temperature sensor is equal to or greater than the measurement result of the second temperature sensor, and
the control device switches from the normal operating mode to the intermittent operating mode in a case the measurement results of the first temperature sensor and the second temperature sensor are less than the threshold and the measurement result of the first temperature sensor is less than the measurement result of the second temperature sensor.

5. The temperature adjusting device according to claim 4, comprising a radiator thermally that is connected to the temperature adjusting circuit and that is configured to cool the thermal medium,
wherein the control device has a cooling operating mode of cooling the thermal medium using the radiator in a case the measurement results of the first temperature sensor and the second temperature sensor are equal to or greater than the threshold.

6. The temperature adjusting device according to claim 1, wherein the heat generating instrument includes a driving device configured to drive a motor.

7. The temperature adjusting device according to claim 1, wherein the heat generating instrument includes a charging device that is electrically connected to an external power supply and that is configured to charge the battery.

8. A vehicle comprising the temperature adjusting device according to claim 1.
